(19) United States
(12) Patent Application Publication
(10) Pub. No.: US 2009/0100575 A1
(43) Pub. Date: Apr. 23, 2009

(54) Securing an RFID Tag to a Garment

(75) Inventor: Trevor Darnborough, Cusworth (GB)

Correspondence Address: ARTHUR JACOB, 25 EAST SALEM STREET, P.O. BOX 686, HACKENSACK, NJ, 07602, US

(73) Assignee: DARNBRO LIMITED, Cusworth (GB)

(21) Appl. No.: 12/025,121

(22) Filed: Mar. 13, 2008

(30) Foreign Application Priority Data
Feb. 2, 2007 (GB) 07 02 004.3

(51) Int. Cl. A41D 27/08; G08B 13/14; D05B 23/00

(52) U.S. Cl. 2/244; 340/572.1; 112/475.09; 112/475.18

(57) ABSTRACT

A fabric garment comprises a design or logo sewn onto the fabric using thread and a radio frequency identification tag secured to the fabric by the thread. In one embodiment, the tag comprises a first insulating layer, a chip, an antenna connected to the chip and formed by a conductive track on the first insulating layer, and a second insulating layer. The first and second insulating layers form insulating areas between portions of the conductive track. The tag is secured to the garment by said thread, and the thread that passes through said tag passes only through the insulating areas of said tag. In another embodiment, the tag comprises a chip and an antenna comprising at least one conductive strand having a first end conductively connected to the chip, and at least part of the logo is embroidered using the first conductive strand.

### TECHNICAL FIELD

The present invention relates to a garment to which a radio frequency identification tag is secured.

### BACKGROUND OF THE INVENTION

Radio frequency identification (RFID) are used by manufacturers and retailers of goods in stock control and security systems. For example, an RFID tag applied to crates or pallets in a warehouse may be scanned to identify the contents, and tags placed on items in shops can be used tags placed on items in shops can be used to set off an alarm if an item is taken out of the shop without its tag being deactivated at point of sale. However, RFID tags are unsuitable for more permanent solutions because they very fragile. In particular, an RFID tag applied to a garment will not survive a cycle in a washing machine.

### BRIEF SUMMARY OF THE INVENTION

According to a first aspect of the present invention, there is provided a fabric garment comprising a design sewn onto the fabric using thread, and a radio frequency identification tag, said tag comprising a first insulating layer, a chip, an antenna connected to said chip and formed by a conductive track on said first insulating layer, and a second insulating layer, said first and second insulating layers forming insulating areas between portions of the conductive track, wherein said tag is secured to said garment by said thread, and the thread that passes through said tag passes only through said insulating areas of said tag.

According to a second aspect of the present invention, there is provided a fabric garment having a logo embroidered thereon and a radio frequency identification tag secured to the fabric, said tag comprising a chip and an antenna comprising at least one conductive strand having a first end conductively connected to said chip, wherein at least part of said logo is embroidered using said first conductive strand.

### BRIEF DESCRIPTION OF THE SEVERAL VIEWS OF THE DRAWINGS

FIG. 1 shows a school environment in which the invention can be used;

FIG. 2 shows an example of a system suitable for use in the environment shown in FIG. 1;

FIG. 3 illustrates the field of view of a UHF read antenna;

FIG. 4 details steps carried out by the system shown in FIG. 2 to detect RFID tags;

FIG. 5 illustrates an RFID tag shown in FIG. 2;

FIG. 6 illustrates a jumper incorporating the RFID tag illustrated in FIG. 5;

FIG. 7 shows a method of incorporating the RFID tag illustrated in FIG. 5 into the jumper shown in FIG. 6;

FIG. 8 illustrates an alternative RFID tag suitable for use in the system shown in FIG. 2;

FIG. 9 illustrates a jumper incorporating the RFID tag illustrated in FIG. 8;

FIG. 10 shows a method of incorporating the RFID tag illustrated in FIG. 8 into the jumper shown in FIG. 6;

FIG. 11 illustrates an alternative environment in which the invention can be used;

FIG. 12 shows an example of a system suitable for use in the environment shown in FIG. 11;

FIG. 13 illustrates the field of view of an HF read antenna;

FIG. 14 illustrates an RFID tag shown in FIG. 12;

FIG. 15 illustrates a T-shirt incorporating the RFID tag illustrated in FIG. 14; and

FIG. 16 shows a method of incorporating the RFID tag illustrated in FIG. 12 into the T-shirt shown in FIG. 15.

### DESCRIPTION OF THE BEST MODE FOR CARRYING OUT THE INVENTION

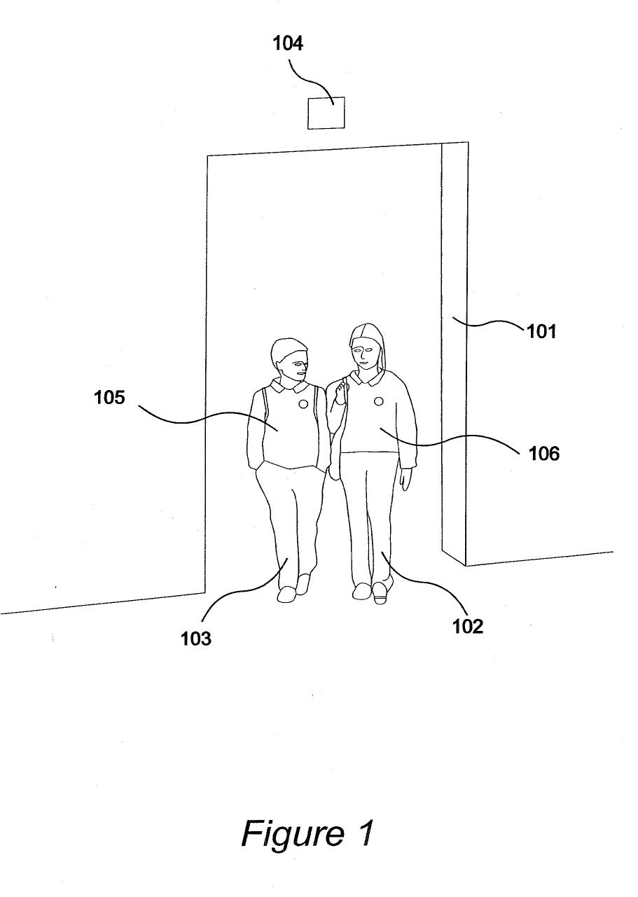

### FIG. 1

In many school environments it is now necessary for teachers to register the presence of each child at every lesson. This can be a lengthy process that reduces the time available for teaching. FIG. 1 shows a doorway 101 in a school through which children such as children 102 and 103 are passing. Above the doorway 101 is a read antenna 104. Each child is wearing school uniform, so that child 102 is wearing jumper 105 and child 103 is wearing jumper 106. Each of jumpers 105 and 106 is fitted with an RFID tag. Read antenna 104 detects the tags, each of which is uniquely numbered, and thus the presence of each child within the room is detected. The name of each child can then be shown on the teacher's computer, and he or she need do no more than ensure that the number of children present matches that on the computer before proceeding with the lesson.

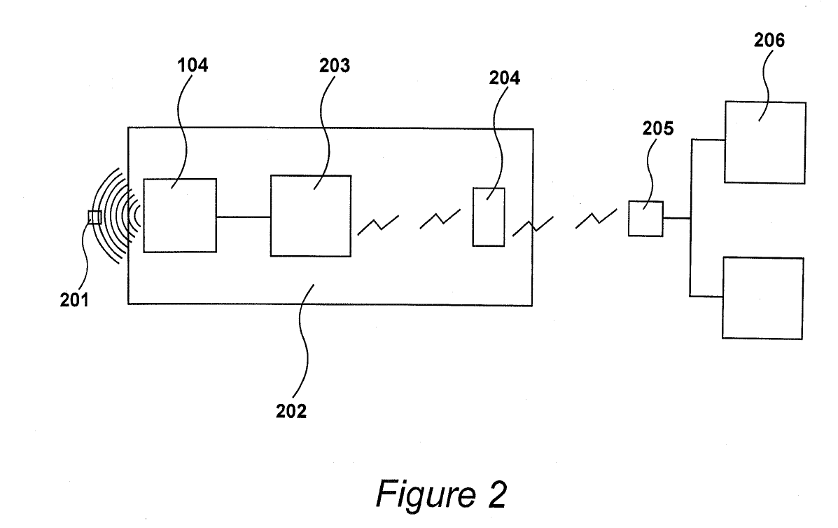

### FIG. 2

An example of a system suitable for use in this environment is shown in FIG. 2. An RFID tag 201, such as that within jumper 105, is detected by a reading system 202. This includes read antenna 104, receiver 203 and computer 204. Read antenna 104, which is connected to receiver 203 by a wire, is an ultra-high frequency (UHF) antenna which emits radio waves in the ultra high frequency band of 860 to 960 mHz. Any signal that read antenna 104 receives, for example from tag 201, is passed to receiver 203, which includes a transceiver that receives the signal and a decoder which translates it into code.

Receiver 203 is connected, in this example via a wireless Bluetooth® link, to computer 204. In this example computer 203 is a small handheld computer such as a personal digital assistant (PDA) that the teacher will find easy to transport, but the computer could be any equipment capable of communicating with a receiver to interpret signals received from tags. Computer 204 is in turn wirelessly connected to an access point 205 that gives access to the main school network which includes a server 206 on which pupil details are stored. Thus, in this example, an ID received by computer 204 from receiver 203 is passed to server 206 which returns the name of the pupil associated with that ID. Thus as soon as the pupil passes through doorway 101 his or her name appears on computer 204.

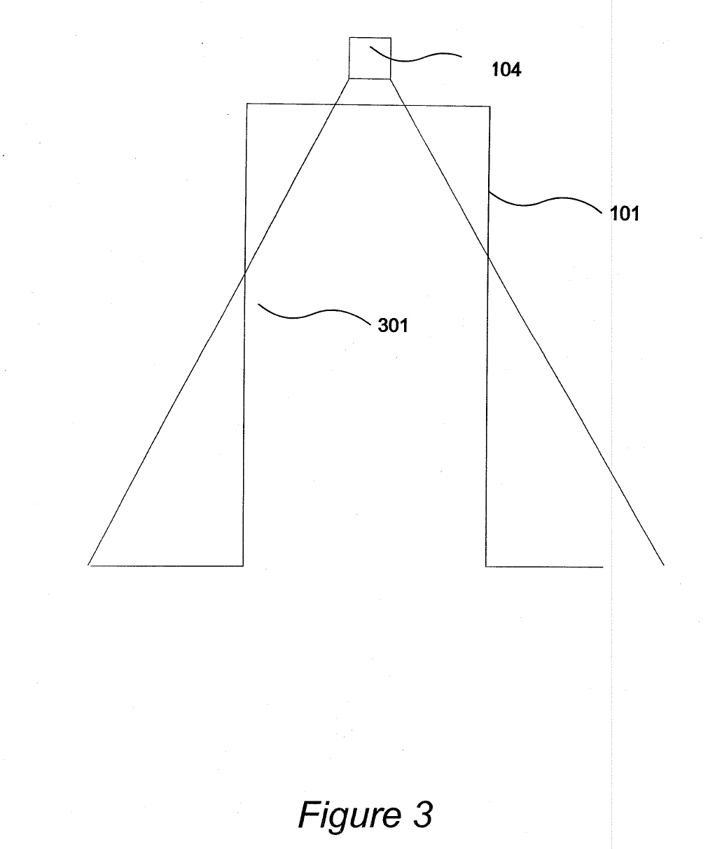

### FIG. 3

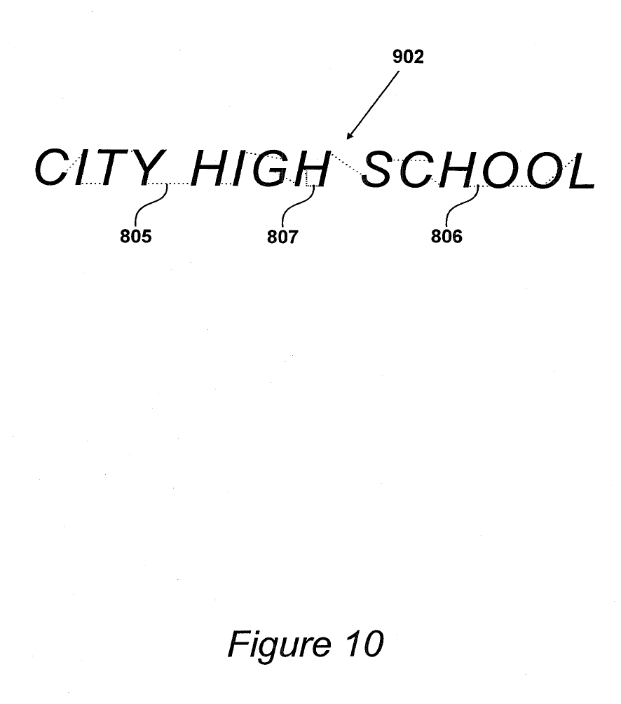

FIG. 3 illustrates the field of view of read antenna 104 of the doorway 101. Read antenna 104 operates in the UHF band and it is its electrical field 301 that senses RFID tags. The electrical field is a beam emitted downwards from the antenna with a divergence of approximately 65°, and thus most of the doorway 101 is covered by a single antenna. As will be discussed with reference to FIG. 10, this compares favourably with the coverage provided by high frequency (HF) read antennae.

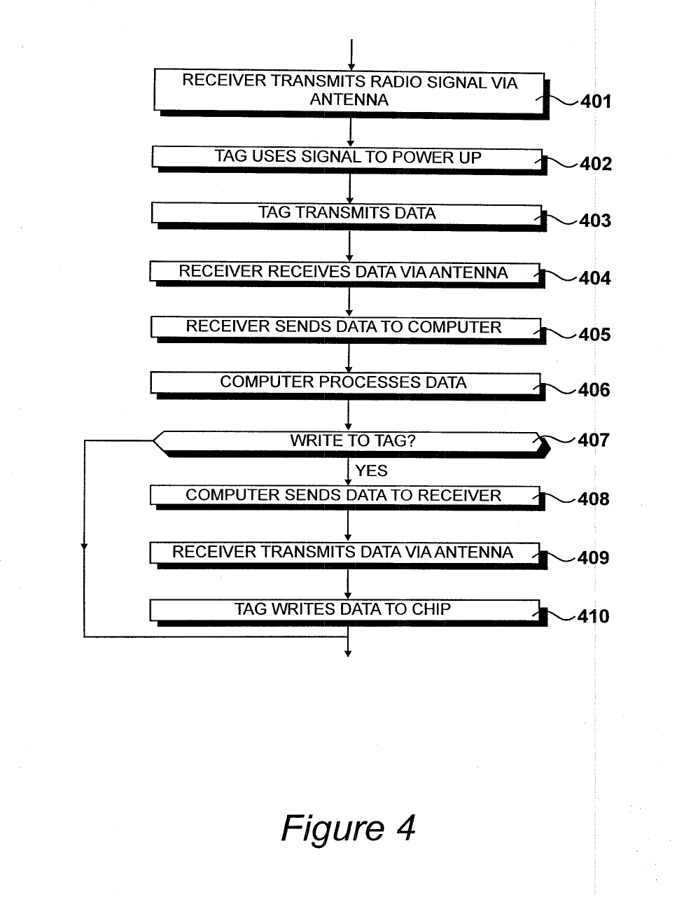

### FIG. 4

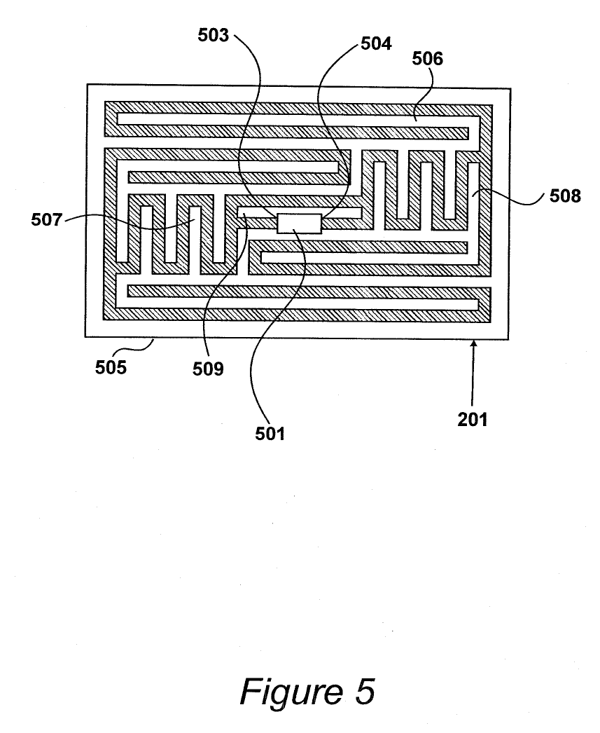

FIG. 4 details the steps carried out by the system shown in FIG. 2 to detect RFID tags passing through the beam of read antenna 104. At step 401 read system 202 transmits a radio-frequency signal comprising electro-magnetic waves of energy using read antenna 104. At step 402 an RFID tag, such as tag 201, uses the signal to power up, as will be explained further with reference to FIG. 5, and at step 403 the tag transmits data stored on it. At step 404 the receiver receives this data via the read antenna and at step 405 the receiver 203 sends the data, converted into a suitable format, to computer 204. At step 406 computer 204 processes the received data, which in this example includes interrogating server 206 for information relating to the unique ID received.

The tag may contain other data along with the unique ID. For example, it may contain the pupil's name, thus reducing the need to communicate with server 206. It may also be possible to write data to the tag, for example the time at which the pupil entered the classroom, and thus at step 407 a question is asked as to whether writing should take place. If this question is answered in the negative then the step of reading the tag is complete, but if it is answered in the affirmative then at step 408 computer 204 sends the relevant data to receiver 203, which transmits it via read antenna 104 at step 409. At step 410 the tag writes the received data to the chip and the process is complete.

Many read systems, each comprising a read antenna, a receiver and a computer, can be used, for example one over each door in the school. Further, although in this example each receiver is programmed to communicate with a single computer, some or all of the receivers could be designed to communicate with a central computer, meaning that a computer is shared between read systems. In particular, there could be a read system at each main entrance to a school so that the presence of a pupil on the school site is known, which could be of life-saving use in an emergency situation such as a fire. In this case, and should the presence of personal data on the RFID tag be a security concern, data could be erased as the pupil leaves the school and rewritten when he or she enters the next morning. Thus even if a pupil's uniform is stolen a person could not extract personal details from the RFID tag once it has left the site.

### FIG. 5

Tag 201 is illustrated in FIG. 5. It includes a silicon chip 501 and a tag antenna 502. Because the chip operates in the UHF band it requires a dipole antenna 502 which is connected to chip 501 at point 503 and point 504 on either side of the chip. The length of the antenna on each side of the chip should be equal and determines the frequency at which the tag operates. If the length on each side is not equal then the frequency is determined by the shorter length.

The ability to use varying frequencies is useful because the frequency determines the read range, with a higher frequency tag being readable further away from the read antenna than a lower frequency tag. It also provides a degree of filtering, wherein tags that are not at approximately the expected frequency may be ignored. This could be useful in a system where RFID tags from other systems frequently pass within the range of the read antenna.

Tag antenna 502 is a thin layer of aluminium foil. The chip 501 and tag antenna 502 are encased in a thin sheath 505 made from an insulating material, in this example plastic. The sheath provides protection against water, but a very small degree of bending can crack the tag antenna, thus rendering it useless. In particular, tags sewn into garments using prior art methods are generally not strong enough to withstand a washing machine cycle. The sheath 505 is made up of a first insulating layer on which the foil antenna 502 is formed by a conductive track and to which the chip 501 is attached. It also comprises a second insulating layer on top of the chip and antenna, and the whole is sealed to form the sheath 505. Thus the first and second layers form insulating areas between portions of the conductive track, such as, but not limited to, insulating areas 506, 507, 508 and 509.

When tag 201 passes within range of a radio signal propagating from a read antenna, such as read antenna 104, the electric field 301 of the read antenna capacitatively couples with the tag antenna 502 to induce an electric current flowing on the tag antenna. This current powers the chip 501, enabling it to send back its own signal that is received by read antenna 104. This is an example of a passive RFID tag. Active RFID tags are also available that include a battery. These can be used at a much greater distance from a read antenna because they do not need to extract power from the radio signal, but there is a requirement to monitor and change the battery. Active tags could be used in a system such as that described herein but passive tags are preferred.

In this example, the chip 501 includes an EEPROM comprising 64 bits of non-volatile memory on which data can be written, although chips without an EEPROM or with more memory can be used. The chip is pre-programmed with a unique ID, ensuring that every RFID tag can be uniquely identified.

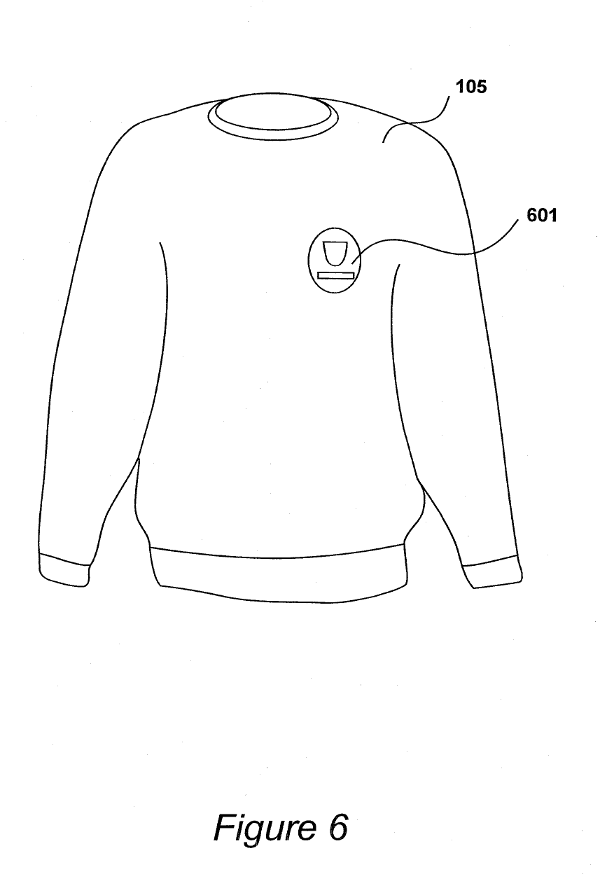

### FIG. 6

Jumper 105, part of the school uniform of pupil 103, is illustrated in FIG. 6. The school logo 601 is embroidered on to the jumper. As previously discussed, traditionally RFID tags have only been used in garments for the purposes of stock control and security in retail outlets, because they break so easily. However, in the invention described herein the RFID tag is incorporated into logo 601, thus giving it protection against every day wear and tear and washing. This may be done in several ways, examples of which are described herein.

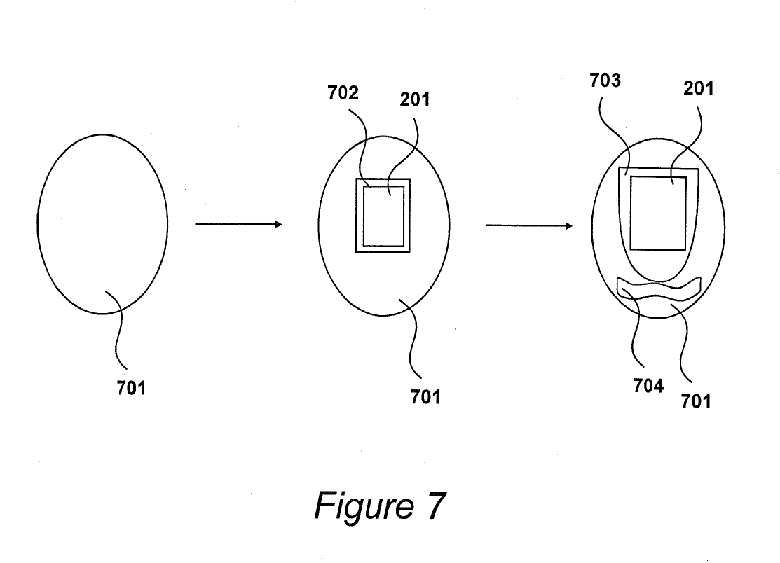

### FIG. 7

A first method of incorporating an RFID tag into a design on a garment is shown in FIG. 7. Firstly, a background 701 is embroidered onto jumper 105. In this example, background 701 is an oval of a first colour. An RFID tag such as tag 201 is then placed on background 701 and held in place by stitching thread 702 around the edge of the tag. The logo 601, which in this example is a coat of arms 703 and motto 704, is sewn over the top of tag 201. In places where the logo 601 covers tag 201, the thread of the stitching passes through the tag. This thread passes only through insulating areas of the tag, such as areas 506, 507, 508 and 509, and not through the chip 501 or antenna 502. This is ensured by precise positioning of the tag, precise stitching of the design and careful matching of the layout of the tag with the layout of the design. In this example the thread is embroidery thread, but the thread may be any thread suitable for sewing a design onto fabric and may for example include nylon thread.

Thus the jumper 105 comprises a design, in this case logo 601, sewn onto the fabric of jumper 105 using thread, and RFID tag 201 is secured to the fabric by the thread. The thread that passes through the tag 201 passes only through insulating areas of the tag. There is a layer of embroidery 701 applied to the fabric underneath the logo 601, and tag 201 is secured between layer 701 and logo 601. Tag 201 is prevented from bending by the stitching through the sheath, and thus the foil tag antenna is protected from breakage.

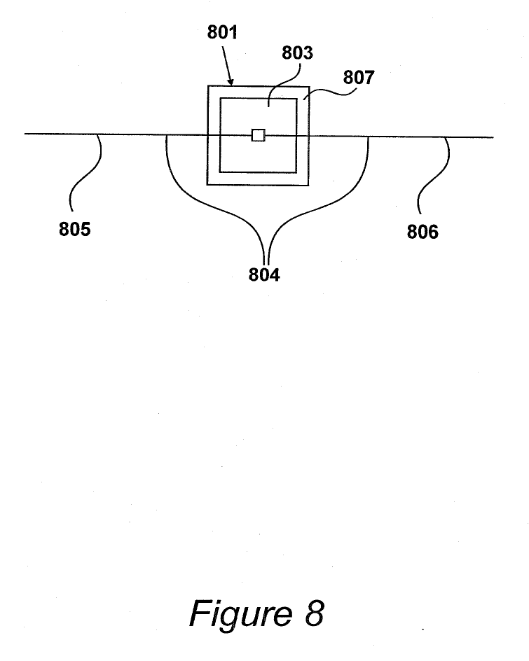

### FIG. 8

FIG. 8 illustrates an alternative RFID tag 801 suitable for use in the system shown in FIG. 2. It comprises a chip 802 secured to a piece of conductive fabric 803 by conductive adhesive. Antenna 804 comprises a first conductive strand 805 connected to one side of chip 802 and a conductive strand 806 connected to the other side of chip 802. Again, chip 802 operates in the UHF frequency and so tag antenna 804 is a dipole antenna. Conductive strands 805 and 806 are in this example strands of thread through and round which a conductive fibre is woven, but any kind of conductive strand suitable for sewing a logo may be used.

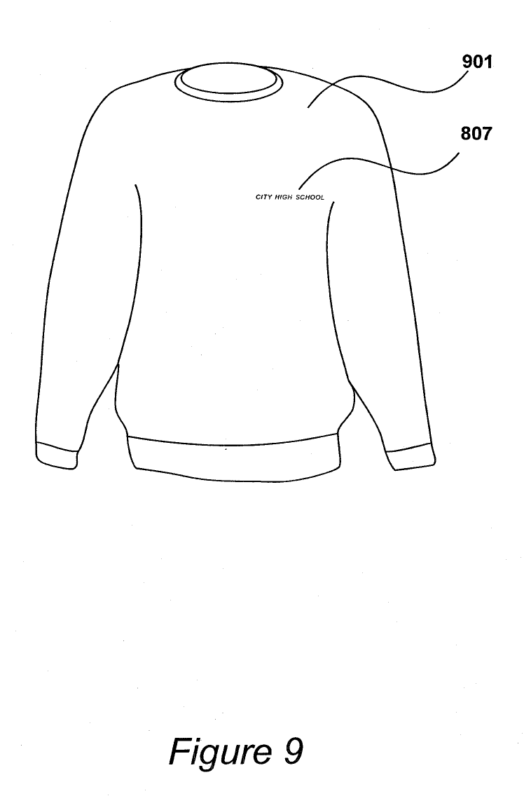

### FIG. 9

A jumper 901 that incorporates RFID tag 801 is shown in FIG. 9. In this example the logo 902 applied to jumper 901 comprises the words CITY HIGH SCHOOL. The words are embroidered using antenna 804. Thus a logo may comprise an image only, words only, or a combination of the two.

### FIG. 10

FIG. 10 illustrates the application of RFID tag 801 to jumper 901. The plastic sheath 807 is placed in a further protective sheath made of fabric and located in position on the reverse side of the fabric, ie on the inside of the jumper. Conductive strand 805 is used to embroider the logo CITY HIGH, working backwards from the final H, while conductive strand 806 is used to embroider the SCHOOL. Part of the stitching using conductive strand 805 secures plastic sheath 807 to the garment.

Alternatively, chip 801 could be secured to jumper 901 by a logo similar to logo 601. In this case, sheath 807 is placed either directly on to the garment or on a first layer of embroidery, and the design is embroidered on top of it using, for at least part of the logo, conductive strands 805 and 806.

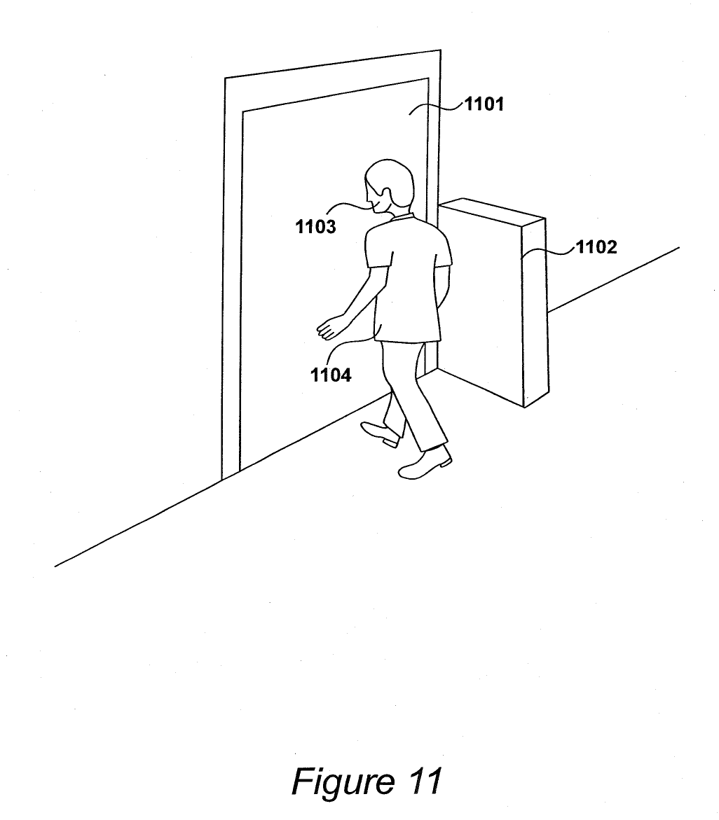

### FIG. 11

An alternative environment in which an embodiment of the system can be used is shown in FIG. 11. In this example a locked door 1101 has a high frequency (HF) antenna 1102 adjacent to it. This embodiment would be appropriate for use in, for example, a retail or factory environment where employees typically wear uniform and where authorisation is required to enter certain parts of the building. This may be in order to keep the public out or to provide different levels of access to different employees. Employee 1103 is wearing a T-shirt 1104 that includes an RFID tag. The tag is sensed by read antenna 1102 and the door 1101 may be unlocked depending upon the permissions level of employee 1103.

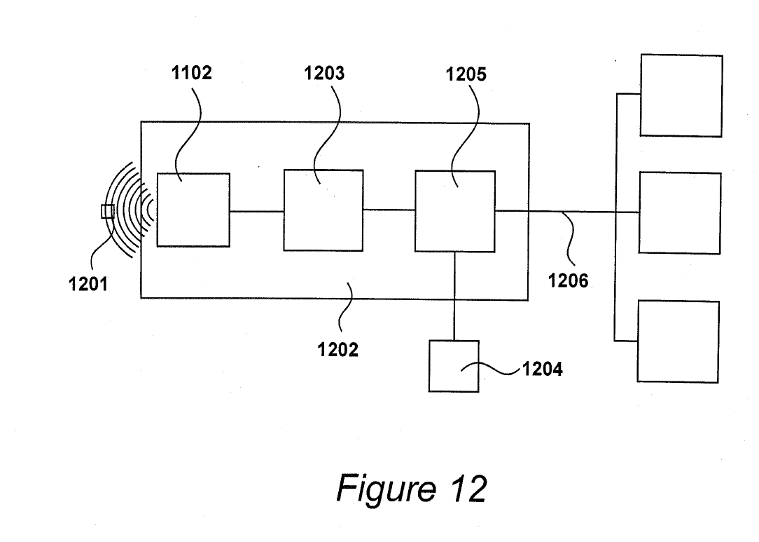

### FIG. 12

FIG. 12 shows a read system 1202 suitable for use in the environment shown in FIG. 11. Read antenna 1102 scans at 13.56 mHz and detects an RFID tag, such as RFID tag 1201 in T-shirt 1104. Receiver 1203 is connected to read antenna 1102 and to an electronic door lock 1204. The system further includes a computer 1205 connected to a network 1206. The receiver 1203 passes a decoded signal to computer 1205 which accesses the records associated with the unique identifier of tag 1201 to determine whether or not to unlock door mechanism 1204. In an alternative embodiment, the receiver could be part of the computer. Additionally, the permissions could be stored on chip 802 rather than on a computer.

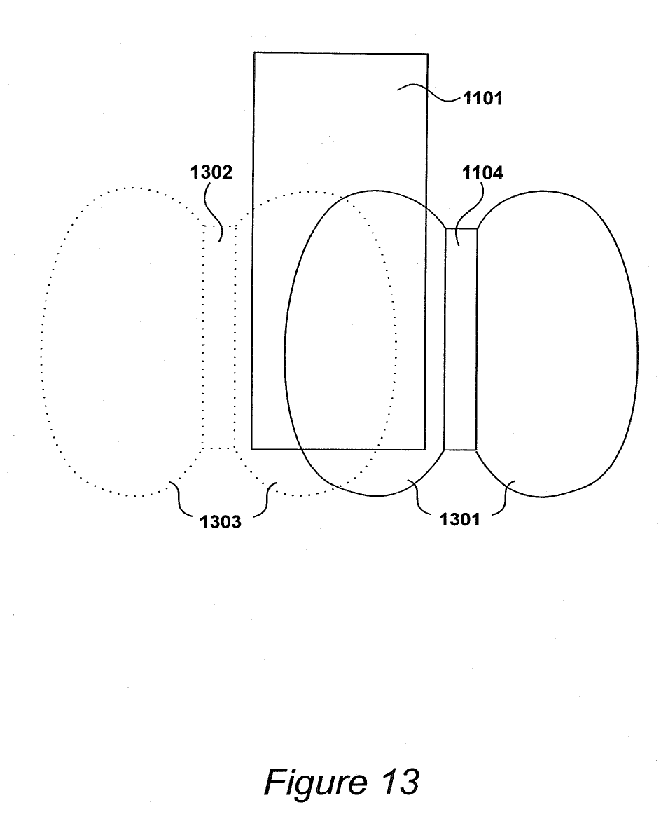

### FIG. 13

FIG. 13 illustrates the coverage provided by read antenna 1104. An HF antenna operates using its magnetic field 1301, which only covers part of door 1101. However, in this embodiment it is not in the interests of employee 1103 to avoid the antenna. In other embodiments it may be necessary to cover an entire doorway, in which case a second read antenna, shown as a dotted line, could be used. Its magnetic field 1303 would overlap with field 1301 thus providing coverage for the entire door 1101.

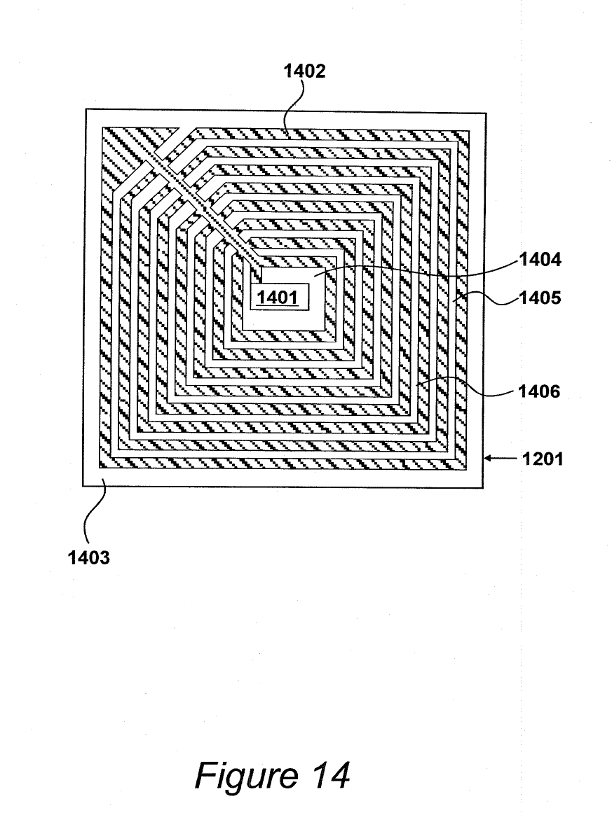

### FIG. 14

FIG. 14 illustrates HF RFID tag 1201 which is secured to T-shirt 1104. It includes a silicone chip 1401 designed to operate at a frequency of 13.56 mHz and a closed loop tag antenna 1402 formed by a conductive foil track arranged in a coil around the chip. The chip and the antenna are encased in plastic sheath 1403, the two insulating layers of which form insulating areas between portions of the conductive track such as portions 1404, 1405 and 1406.

HF tag 1201 operates similarly to UHF tag 201 except that it is the magnetic field of read antenna 1104 that powers up the tag using inductive coupling. A system using HF tags and readers has the disadvantages that the read antennae are larger with a shorter range and the frequency cannot be varied, but the advantage that occasionally HF tags can be used in situations where UHF tags cannot. The choice of system is dependent upon the application.

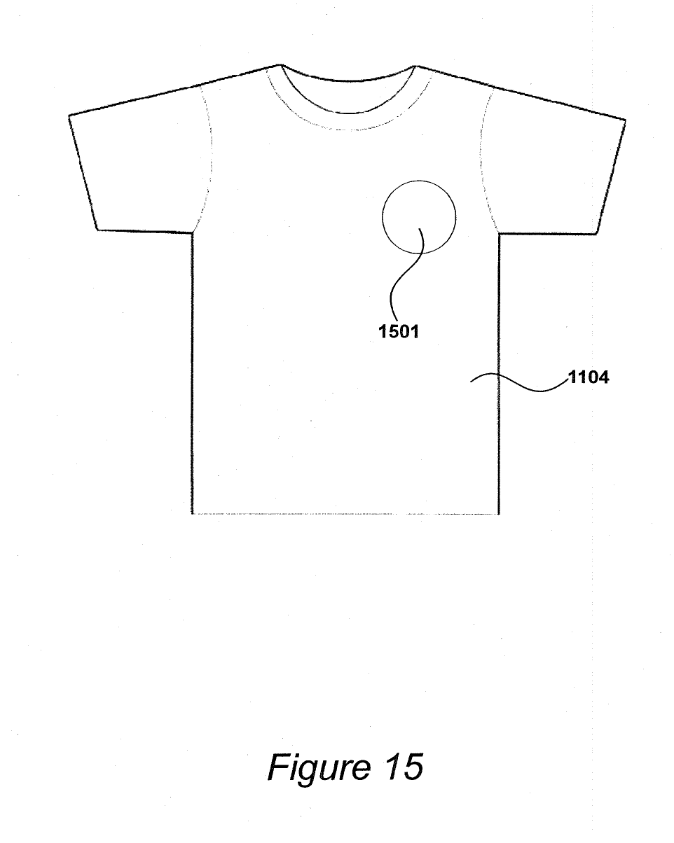

### FIG. 15

Tag 1201 can be attached to T-shirt 1104 in the same way as tag 201 is attached to garment 105, ie by embroidering a design or logo over it. However, another option is shown in FIG. 15. Badge 1501 is either woven or pre-embroidered with a logo and is sewn on to the T-shirt on top of tag 1201.

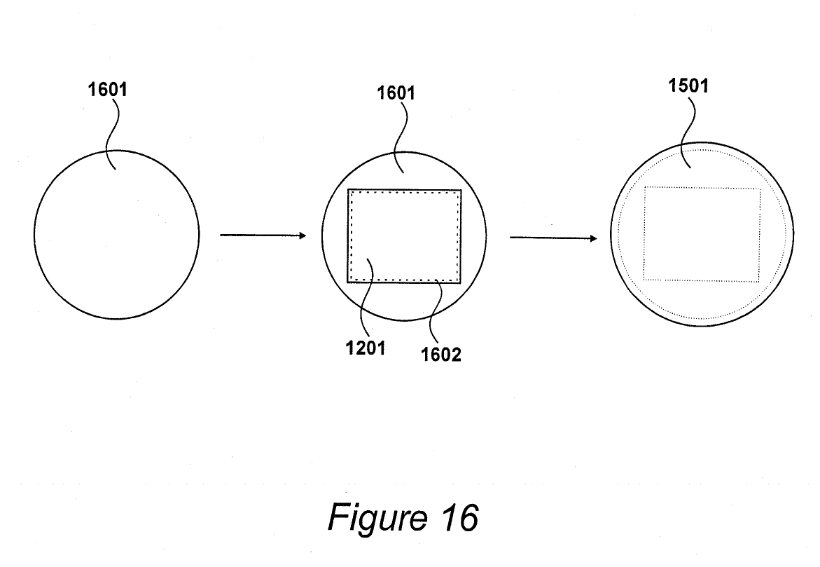

### FIG. 16

Firstly, a layer of embroidery 1601 is sewn on to the T-shirt and tag 1201 is then stitched in place using thread 1602. Badge 1501 is then placed over the top of the hole and optionally sewn down by adding extra embroidery to the badge, ensuring that the thread passes through parts 1404 of plastic sheath 1403 not in contact with either the chip or the antenna. Thus the tag 1201 is secured to the fabric and protected from rough handling by the embroidery and the badge. Alternatively, the initial layer of embroidery 1601 could be omitted if there is enough stitching through the tag to protect it.

This method could also be used for securing UHF tags 201 or 801 to a garment. A further method involves encapsulating the tag within badge 1501 before applying it to a garment.

1. A fabric garment comprising
a design sewn onto the fabric using thread; and
a radio frequency identification tag, said tag comprising a first insulating layer, a chip, an antenna connected to said chip and formed by a conductive track on said first insulating layer, and a second insulating layer, said first and second insulating layers forming insulating areas between portions of the conductive track; wherein
said tag is secured to said garment by said thread, and the thread that passes through said tag passes only through said insulating areas of said tag.

2. A garment according to claim 1, wherein said tag is an ultra high frequency tag and said antenna is a dipole antenna.

3. A garment according to claim 1, wherein said tag is a high frequency tag.

4. A garment according to claim 1, wherein said design is a woven or pre-embroidered badge that is sewn to the garment using said thread.

5. A garment according to claim 1, wherein said design is embroidered onto said garment using said thread.

6. A garment according to claim 1, wherein said garment further comprises a layer of embroidery applied to said fabric underneath said design, and said tag is secured between said layer and said design.

7. A garment according to claim 1, wherein said chip is a passive chip.

8. A garment according to claim 1, wherein said chip includes non-volatile memory.

9. A system for registering the presence of a person, comprising
a plurality of garments according to claim 1, wherein the tag in each garment comprises a chip having a unique identification number;
a receiving antenna for detecting said tags;
a receiver connected to said receiving antenna; and
a computer connected to said receiver.

10. A fabric garment having a logo embroidered thereon and a radio frequency identification tag secured to the fabric, said tag comprising a chip and an antenna comprising at least one conductive strand having a first end conductively connected to said chip, wherein at least part of said logo is embroidered using said first conductive strand.

11. A garment according to claim 10, wherein said tag further comprises a a plastic sheath encasing said chip and said first end of the conductive strand;

12. A garment according to claim 10, wherein said tag further comprises a conductive fabric to which the chip and the antenna are attached.

13. A garment according to claim 12, wherein said chip and said antenna are attached to said conductive fabric using conductive adhesive.

14. A garment according to claim 10, wherein said tag is an ultra high frequency tag and said antenna further comprises a second conductive strand having a first end connectively connected to said chip, and wherein at least part of said logo is embroidered using said second conductive strand.

15. A garment according to claim 10, wherein said tag is a high frequency tag.

16. A garment according to claim 10, wherein said chip is a passive chip.

17. A garment according to claim 10, wherein said chip includes non-volatile memory.

18. A system for registering the presence of a person, comprising
a plurality of garments according to claim 10, wherein the tag in each garment comprises a chip having a unique identification number;
a receiving antenna for detecting said tags;
a receiver connected to said receiving antenna; and
a computer connected to said receiver.

19. A method of attaching a radio frequency identification tag to a garment, comprising the steps of:
providing a tag comprising a first insulating layer, a chip, an antenna connected to said chip and formed by a conductive track on said first insulating layer, and a second insulating layer, said first and second insulating layers forming insulating areas between portions of the conductive track; and
securing said tag to said garment by sewing a design onto said garment and on top of said tag, wherein the thread of said sewing that passes through the tag passes only through said insulating areas of said tag.

20. A method according to claim 19, wherein said tag is a high frequency tag.

21. A method according to claim 19, wherein said tag is an ultra high frequency tag and said antenna is a dipole antenna.

22. A method according to claim 19, wherein said step of securing said tag to said garment comprises the steps of:
sewing a layer of embroidery onto said garment;
placing said tag on said layer; and
sewing said design on top of said tag such that the tag is held between said layer and said design.

23. A method according to claim 19, wherein said step of sewing a design onto said garment comprises sewing a woven or embroidered badge to the garment.

24. A method according to claim 23, wherein said step of securing said tag to said garment comprises the steps of:
sewing said tag to the back of said badge; and
sewing said badge to said garment.

25. A method according to claim 19, wherein said step of sewing a design onto said garment comprises embroidering a design directly onto said garment.

26. A method of attaching a radio frequency identification tag to a garment, comprising the steps of:
providing a tag comprising a chip and an antenna, said antenna comprising at least one conductive strand having a first end conductively connected to said chip; and
securing said tag to said garment by embroidering at least a first part of a logo onto said garment using said conductive strand.

27. A method according to claim 26, wherein said tag further comprises a conductive fabric to which the chip and the antenna are attached.

28. A method according to claim 27, wherein said chip and said antenna are attached to said conductive fabric using conductive adhesive.

29. A method according to claim 26, wherein said tag is a high frequency tag.

30. A method according to claim 26, wherein said tag is an ultra high frequency tag and said antenna further comprises a second conductive strand conductively connected to said chip, further including the step of embroidering a second part of the logo using said second conductive strand.

31. A method according to claim 26, wherein said logo is embroidered directly onto said fabric.

32. A method according to claim 26, wherein said logo is embroidered onto a badge and said badge is sewn to said fabric garment.
